(19) United States
(12) Patent Application Publication
(10) Pub. No.: US 2017/0117654 A1
(43) Pub. Date: Apr. 27, 2017

(54) ELECTRONIC CIGARETTE CONNECTOR

(71) Applicant: Dennis Cruz, Los Angeles, CA (US)

(72) Inventor: Dennis Cruz, Los Angeles, CA (US)

(21) Appl. No.: 15/336,695

(22) Filed: Oct. 27, 2016

Related U.S. Application Data
(60) Provisional application No. 62/246,757, filed on Oct. 27, 2015.

(51) Int. Cl. H01R 13/24; H01R 13/622; A24F 47/00

(52) U.S. Cl. CPC H01R 13/2421; A24F 47/008; H01R 13/622

(57) ABSTRACT

An electronic cigarette connector may include a body, an insulator, a center pin, a resilient unit and a bottom cap. The body is used for housing the connectors and the insulator is used as both the heat insulator and the polarity insulator. The center pin is a power connector made by conductive materials. When in use, an atomizer is electrically connected to an upper surface of the center pin and pushes the center pin down to electrically connect to the power source. Since the center pin and the resilient unit are encapsulated by the bottom cap, when the center pin is pushed down, a lower portion of the center pin protrude out from the bottom cap to connect to the power source to ensure the electrical conductivity regardless of the thread depth or height of the atomizer.

### CROSS-REFERENCE OF RELATED APPLICATIONS

This application claims priority under 35 U.S.C. §119 (e) to U.S. Provisional Patent Application Ser. No. 62/246,757, filed on Oct. 27, 2015, the entire contents of which are hereby incorporated by reference.

### FIELD OF THE INVENTION

The present invention relates to a fitting part for an electronic cigarette, and more particularly to a retractable connector for an electronic cigarette.

### BACKGROUND OF THE INVENTION

Electronic cigarettes (also referred to as e-cigarettes or personal vaporizers) have been around since the late 80s. People who understand the risks of smoking have decided to use battery-powered electronic vaporizing devices that would create vapors that contained vegetable-extracted, pharmaceutical grade nicotine, which is the most addictive substance found in conventional cigarettes by mixing it with natural food extracts and food grade glycerin.

Electronic cigarettes are generally battery-powered devices that are configured to deliver a vapor that comprises nicotine to an individual. Conventional electronic cigarette designs generally include a battery, a heating element, and a mouthpiece. The mouthpiece includes a liquid solution that comprises nicotine, and the battery provides power to the heating element, which in turn operates to vaporize the solution. Accordingly, when the user places the mouthpiece in her mouth and draws from the mouthpiece, the user receives vaporized nicotine. Due to the ever-increasing taxes on tobacco products, popularity of electronic cigarettes is expected to continue to increase.

One of the most common problems of electronic cigarettes is that there was no standard connector that would accommodate the e-cigarettes devices. As the technology progressed, people who created these personal vaporizing devices have started using a so called “510 cable interface,” which is very similar to a coupler used for braided cable wires for communication, e.g. for cable TV. It uses a Metric M7 diameter hole with a 0.5 mm thread pitch. While this may work to a certain extent, it was unreliable and was not able to withstand the power being used for personal vaporizers. The power being used was 3.7-8.4 volts drawing as much as 35 amperes. Thus, several connectors for personal vaporizers have been developed.

U.S. Patent Publication No. 2013/0152922 to Benassayag discloses a portable pen sized electric herb vaporizer with ceramic heating chamber, as shown in FIG. 1. The vaporizer is an elongated and cylindrical device used to vaporize the active ingredient of or burn herbs, having a battery, a heating compartment, a chamber connector, and a mouthpiece. Two threaded screw interfaces attach the battery to the heating compartment and the heating compartment to the chamber connector. The mouthpiece holds a ceramic filter and is inserted into the chamber connector. The heating compartment has a ceramic heating chamber within which herbs are placed, and a heating coil connected to the battery within the ceramic heating chamber heats the herbs. The user presses an activator button and inhales through the mouthpiece, drawing heated air over the herbs, through the chamber connector and into the user's lungs. The chamber connector has a disk filter to catch ash and a spring that presses on the herbs for efficient vaporization. However, Benassayag did not disclose a connector that is retractable to meet all atomizer heights.

U.S. Patent Publication No. 2014/0150783 to Liu discloses an electronic cigarette having a connector for magnetic connection, including a sucking rod and a power rod detachably connected with the sucking rod, as shown in FIG. 2. The sucking rod includes a replaceable atomizer and a connector for connecting the atomizer and the power rod and transporting electricity of the power rod to the atomizer, the connector is magnetically connected with the atomizer, and detachably connected with the power rod. The electronic cigarette haying a connector for magnetic connection of the present, can decrease manufacture and use cost of the electronic cigarette, and facilitate the installation, detachment and replacement of the electronic cigarette. Even though Liu discloses an improved e-cigarette connector that can be magnetically connected with the atomizer, the connector may not fit to meet all atomizer heights.

U.S. Pat. No. 9,060,548 to Zheng discloses a fast connector of electronic cigarette as shown in FIG. 3, which comprises a battery adaptor plate above a battery, wherein a top surface of the battery adaptor plate is welded with a pair of resilient battery columns; a bottom surface of the battery adaptor plate is welded with a two-pin socket; the two-pin socket and the battery are connected, and the two-pin socket is connected to the resilient battery columns via the battery adaptor plate; upper ends of the resilient battery columns support against a vaporizer socket; a pair of electrode columns and a heating wire are fixed on the vaporizer socket; two ends of the heating wire are welded and conducted with the electrode columns via conduction wires. Like Benassayag and Liu, even though Zheng discloses a fast connector for e-cigarettes, the connector is still not self-adjustable to meet all atomizer heights.

Therefore, there remains a need for a new and improved connector for electronic cigarettes to overcome the problems stated above.

### SUMMARY OF THE INVENTION

It is an object of the present invention to provide an electronic cigarette connector, which is adjustable to meet the height requirement of the atomizers.

It is another object of the present invention to provide an adjustable electronic cigarette connector with a center pin made by conductive materials as a positive power connector.

It is a further object of the present invention to provide an adjustable electronic cigarette connector that is waterproof and able to be used up to 14 AWG wires to handle the amperage requirements.

In one aspect, an electronic cigarette connector may include a body, an insulator, a center pin, a resilient unit, an O-ring seal, and a bottom cap. The body is the housing for the connector. In one embodiment, the body is made by stainless steel, brass, zinc, or copper. In another embodiment, the body may have a locking notch for washer, thread for threaded caps, and may also have a silicone or rubber O-ring for water resistance. In a further embodiment, the body may include an internal thread and external thread, and the internal thread is M7X0.5, while the internal thread is M10X1.0. In still a further embodiment, the external thread can be customized according to the user's preference,

The insulator can be used in two ways: as a heat insulator, and a polarity insulator for both positive and negative contacts used in the connectors. The insulator can be either threaded or unthreaded. In another embodiment, the insulator can be made by plastic materials. In a further embodiment, the insulator can be made by ceramic.

The center pin is used as a power connector for the electronic cigarette connector. In one embodiment, the center pin can be used as a positive power connector. In another embodiment, the center pin can be made by conductive materials such as copper, beryllium copper, brass, or stainless steel. In a further embodiment, the center pin can be made by nickel, rhodium, silver or gold plated for better conductivity. It is noted that the center pin may use horizontal hole instead of vertical hole for wire connection.

The resilient unit is configured to allow the center pin to move up and down to ensure the electrical conductivity regardless of the thread depth or height of the atomizer. The resilient unit can be made mostly by round plated carbon steel. In one embodiment, beryllium copper can be used if the resilient unit will also be used for conductivity purposes. In another embodiment, the resilient unit can be coiled round springs. In a further embodiment, the resilient unit 440 can be flat coil springs, wave springs, and flexible silicone tubing.

In one embodiment, the O-ring can be disposed inside the bottom cap to make the electronic cigarette connector to be water resistant. The O-ring can be made by rubber or silicone depending on the user's preference. In an exemplary embodiment, the center pin, the resilient unit and the O-ring may be encapsulated by the bottom cap. The bottom cap can be made by brass or copper.

The electronic cigarette connector may further include a negative solder tab and a nut. In one embodiment, the solder tab can be used as a negative solder point and it can be made by either copper, brass or stainless steel. The nut is configured to secure the body to the host chassis. The nut can also be made by either copper, brass or stainless steel.

### BRIEF DESCRIPTION OF THE DRAWINGS

FIG. 1 illustrates a prior art disclosing discloses a portable pen sized electric herb vaporizer with ceramic heating chamber.

FIG. 2 illustrates a prior art disclosing an electronic cigarette having a connector for magnetic connection, including a sucking rod and a power rod detachably connected with the sucking rod.

FIG. 3 illustrates a prior art disclosing a fast connector of electronic cigarette.

FIG. 4 is an exploded view of the electronic cigarette connector in the present invention.

FIG. 5 illustrates an internal thread and external thread of the body of the electronic cigarette connector in the present invention.

FIG. 5a illustrates a bottom opening of the bottom cap of the electronic cigarette connector in the present invention.

FIG. 6 is an assembled view of the electronic cigarette connector in the present invention.

FIG. 7 is a schematic view of the electronic cigarette connector in the present invention when in use.

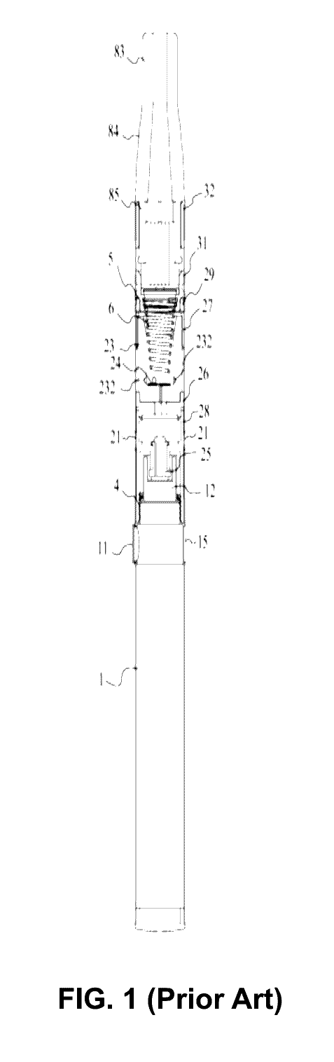

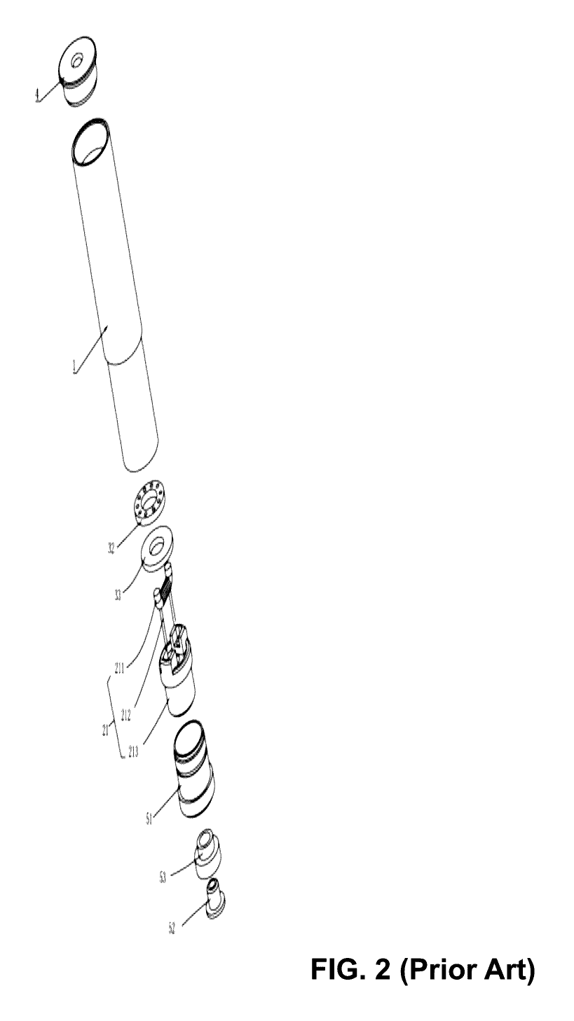

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In order to further understand the goal, characteristics and effect of the present invention, a number of embodiments along with the drawings are illustrated as following:

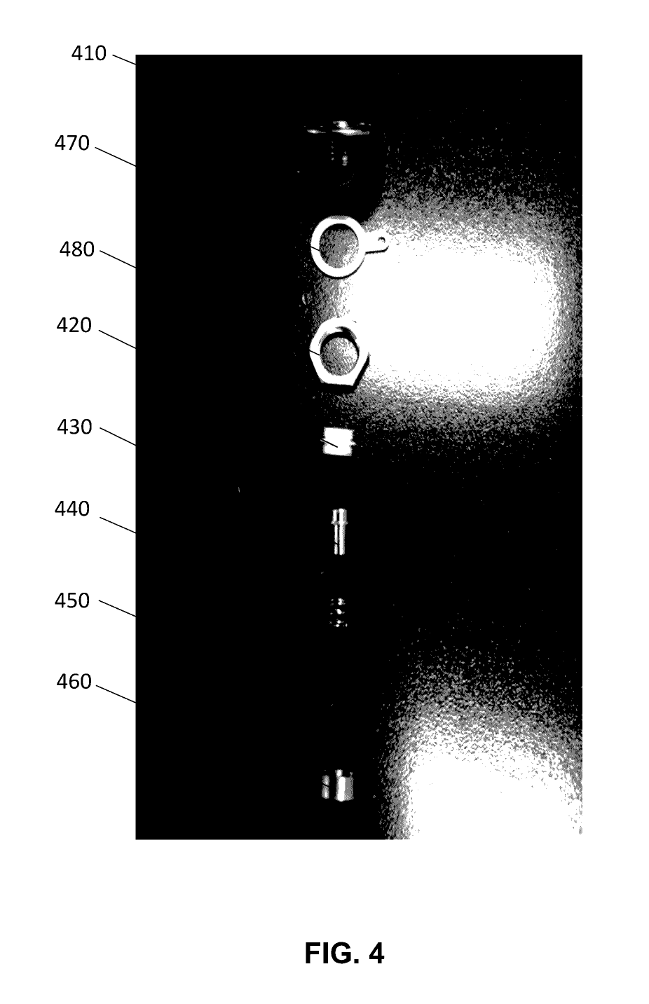

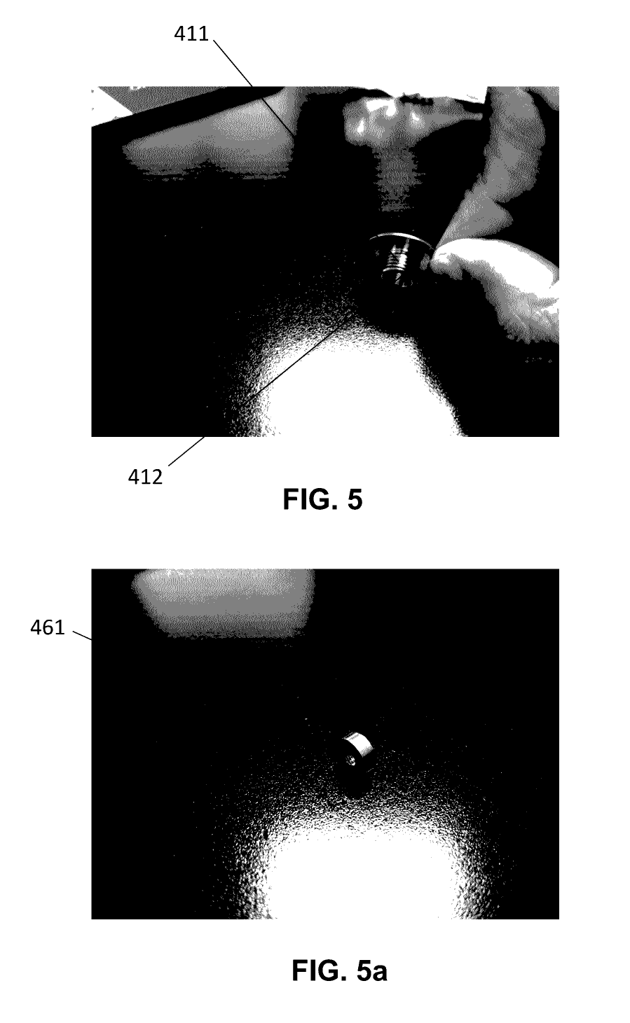

In one aspect, referring to FIG. 4, an electronic cigarette connector may include a body 410, an insulator 420, a center pin 430, a resilient unit 440, a an O-ring 450, and a bottom cap 460. The body 410 is the housing for the center pin 430 and insulator 420. In one embodiment, the body 410 is made by stainless steel, brass, zinc, or copper. In another embodiment, the body 410 may have a locking notch for washer, thread for threaded caps, and may also have a silicone or rubber O-ring for water resistance. In a further embodiment, the body 410 may include an internal thread 411 and external thread 412, as shown in FIG. 5, and the internal, thread 411 is M7X0.5, while the internal thread is M10X1.0. In still a further embodiment, the external thread can be customized according to the user's preference.

The insulator 420 can be used in two ways: as a heat insulator, and a polarity insulator for both positive and negative contacts used in the connectors. The insulator 420 can be either threaded or unthreaded. In another embodiment, the insulator 420 can be made by plastic materials. In a further embodiment, the insulator 420 can be made by ceramic.

The center pin 430 is used as a power connector for the electronic cigarette connector. In one embodiment, the center pin 430 can be used as a positive power connector. In another embodiment, the center pin 430 can be made by conductive materials such as copper, beryllium copper, brass, or stainless steel. In a further embodiment, the center pin 430 can be made by nickel, rhodium, silver or gold plated for better conductivity. It is noted that the center pin 430 may use horizontal hole instead of vertical hole for wire connection.

The resilient unit 440 is configured to allow the center pin 430 to move up and down to ensure the electrical conductivity regardless of the thread depth or height of the atomizer. The resilient unit 440 can be made mostly by round plated carbon steel. In one embodiment, beryllium copper can be used if the resilient unit 440 will also be used for conductivity purposes. In another embodiment, the resilient unit 440 can be coiled round springs. In a further embodiment, the resilient unit 440 can be flat coil springs, wave springs, and flexible silicone tubing.

In one embodiment, the O-ring 450 can be disposed inside the bottom cap 460 to make the electronic cigarette connector to be water resistant. The O-ring 450 can be made by rubber or silicone depending on the user's preference. In an exemplary embodiment, the center pin 430, the resilient unit 440 and the O-ring 450 may be encapsulated by the bottom cap 460. The bottom cap 450 can be made by brass or copper.

The electronic cigarette connector may further include a negative solder tab 470 and a nut 480. In one embodiment, the solder tab 470 can be used as a negative solder point and it can be made by either copper, brass or stainless steel. The nut 480 is configured to secure the body 410 to the host chassis. The nut 480 can also be made by either copper, brass or stainless steel.

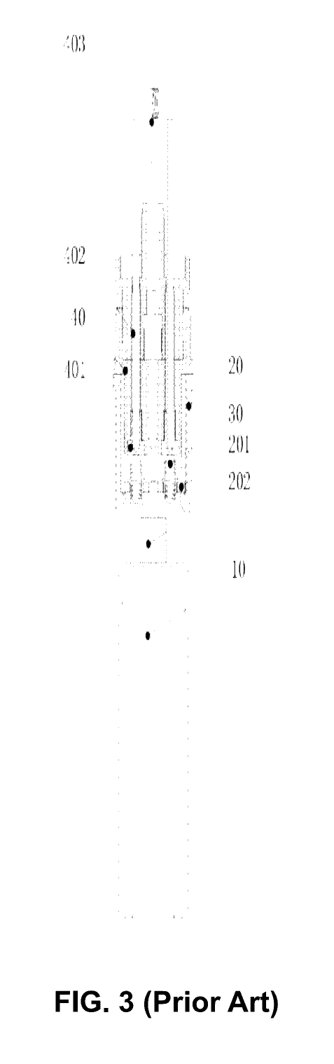

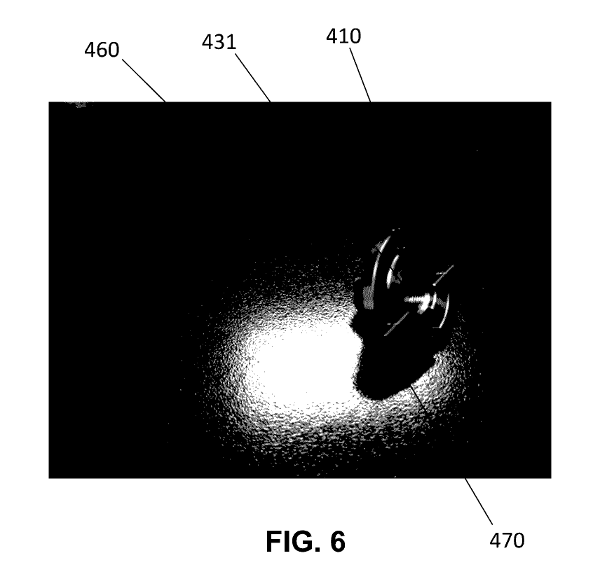

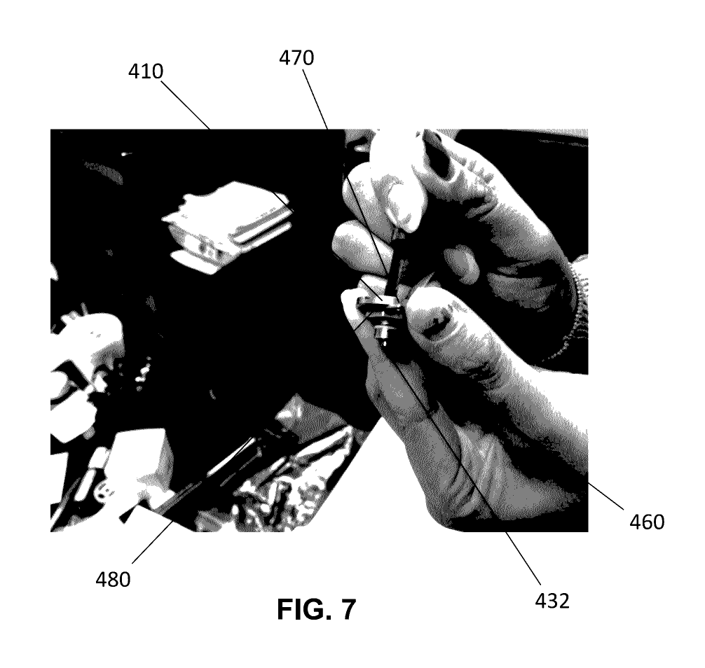

As stated above, the connector is configured to connect the atomizer and the power source to transport electricity front the power source to the atomizer. When in use, referring to FIGS. 6 and 7, an atomizer is electrically connected to an upper surface 431 of the center pin 430 and pushes the center pin 430 down to connect to the power source. In the present invention, since the center pin 430 and the resilient unit 440 are encapsulated by the bottom cap, when the center pin 430 is pushed down, a lower portion 432 of the center pin 430 protrudes out from the through hole 461 at a bottom portion of the bottom cap 460 (see FIG. 3a) to connect to the power source to ensure the electrical conductivity regardless of the thread depth or height of the atomizer.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An electronic cigarette connector comprising:
a center pin configured to be a power connector;
an insulator;
a body for housing the center pin and the insulator;
a resilient unit to cover a lower of portion of the center pin to allow the center pin to retractably move within a predetermined distance; and
a bottom cap to encapsulate the center pin and the resilient unit,
wherein when an atomizer electrically connected to an upper surface of the center pin and pushes the center pin down to enable a lower portion of the center pin protrudes out from a through opening at a bottom portion of the bottom cap to connect to the power source to ensure the electrical conductivity regardless of the thread depth or height of the atomizer.

2. The electronic cigarette connector of claim 1, wherein the body is made by stainless steel, brass, zinc, or copper.

3. The electronic cigarette connector of claim 1, wherein the body includes an internal thread and external thread, and the internal thread is M7X0.5 while the internal thread is M10X1.0.

4. The electronic cigarette connector of claim 1, wherein insulator is either used as a heat insulator or a polarity insulator for both positive and negative contacts.

5. The electronic cigarette connector of claim 1, wherein insulator is made by plastic materials.

6. The electronic cigarette connector of claim 1, wherein insulator is made by ceramic.

7. The electronic cigarette connector of claim 1, wherein the center pin is made by conductive materials such as copper, beryllium copper, brass, or stainless steel.

8. The electronic cigarette connector of claim 1, wherein the resilient unit is coiled round springs.

9. The electronic cigarette connector of claim 1, further comprising an O-ring disposed inside the bottom cap to make the electronic cigarette connector water resistant.

10. The electronic cigarette connector of claim 1, further comprising a negative solder tab, which is used as a negative solder point.

11. The electronic cigarette connector of claim 1, further comprising a nut to secure the body to the host chassis.
